(19) United States
(12) Patent Application Publication
(10) Pub. No.: US 2011/0006685 A1
(43) Pub. Date: Jan. 13, 2011

(54) LIGHTING DEVICE FOR A MOTOR VEHICLE AND METHOD FOR CONTROLLING A LAMP

(75) Inventor: Josef Kraft, Riedstadt (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/671,408

(22) PCT Filed: Jun. 24, 2008
(86) PCT No.: PCT/EP08/05101

§ 371 Date: Sep. 24, 2010

(30) Foreign Application Priority Data
Aug. 1, 2007 (DE) 102007036081.1

(51) Int. Cl. B60Q 1/14

(52) U.S. Cl. 315/77

(57) ABSTRACT

A lighting device is provided for a vehicle with a lamp as well as a sensor device for detecting the reflected light that gets back to the motor vehicle, as well as a controlling device with an analyzing device for evaluating the reflected light from the vehicle and a dimming device that can be used to reduce the intensity of the emitted light.

### CROSS-REFERENCE TO RELATED APPLICATIONS

This application is a U.S. National-Stage entry under 35 U.S.C. §371 based on International Application No. PCT/EP2008/005101, filed Jun. 24, 2008, which was published under PCT Article 21(2) and which claims priority to German Application No. 102007036081.1, filed Aug. 1, 2007, which are all hereby incorporated in their entirety by reference.

### TECHNICAL FIELD

The invention relates to the area of automotive engineering, more specifically to the area of auxiliary and assistant devices for driving motor vehicles.

### BACKGROUND

As traffic density and technical requirements placed on road traffic in general have increased, so too have the demands placed on drivers of motor vehicles. Against this backdrop, various assistant devices have already become known, which mitigate the risk of accident by supporting the driver or automatically intervene in the technical equipment of the vehicle, with the objective of thereby enhancing safety during operation and during use of a motor vehicle.

Among the assistant devices that have become know are distance warning devices and emergency braking devices, lane departure systems, braking assistants, electronic stabilization programs, ABS and a variety of systems for recognizing the vehicle environment.

In addition, driving comfort and safety are enhanced by parking space searching systems and parking assistants.

Systems for controlling lighting systems in motor vehicles have also become known. The latter are mostly aimed at both preventing blinding by oncoming traffic, and giving the driver of the motor vehicle the best possible vision. For example, DE 10 2005 015 578 discloses a lighting system in which a sensor measures the brightness of the driving environment, and based thereupon controls the intensity of emitted light.

Known from DE 38 44 364 is to intensify the lighting for the motor vehicle of the driver if the driver is blinded by oncoming traffic, and illuminate the driver's lane with a higher luminous intensity.

Known from DE 199 50 504 as a further development of this technology is to reduce the luminous intensity of the lamps in the driver's motor vehicle with a certain delay after oncoming traffic has been passed and blinding has subsided.

Known from DE 197 56 574 is an environment detection device with an image recording device in the form of a camera, a device for determining a driving mode, and a control device for controlling one or various lamps of the motor vehicle.

Known from EP 0 571 529 is a system in which a headlamp emits periodic light-induced pulses, wherein a transparent screen arranged in front of the driver exhibits synchronized, variable transparency coefficients, which are controlled in such a way that the reflected light-induced pulses are allowed through, while the extraneous light in between is subdued. As a result, the lighting device inside the vehicle clearly illuminates the road, while extraneous light is reduced to the driver.

Known from WO 03/008232 A1 is a lighting unit for a motor vehicle that illuminates objects with radiant pulses with a frequency so high that the human eye can no longer resolve them, while a receiving unit is operated during the pulses that is better able to discern illuminated objects owing to the high luminous intensity of the pulses. The lamp is controlled by a computer as a function of the evaluated image data relative to the intensity of distribution of the radiant pulses.

The known devices all are either geared toward the prevention of blinding by other respective motor vehicles, or an improvement of perceptibility with respect to objects in the environment of the motor vehicle.

By contrast, another hitherto ignored problem lies in preventing the driver of a motor vehicle from being blinded while approaching obstacles by reflected light from the motor vehicle. For example, while driving toward a wall, in particular the wall of a garage, which most often is also painted in a bright color, the object is not to allow blinding to prevent the driver from correctly recognizing the corresponding obstacles or misjudging distances. This is further facilitated by forward driving in the dark, which increases the sensitivity of the human eye owing to adaptation effects. In particular in older people, this adaptation takes place so slowly that, when approaching an obstacle, the suddenly arising brightness can no longer be balanced out.

Consequently, at least one the object of the present invention is to provide a lighting device for a motor vehicle that prevents blinding by reflected light to the greatest extent possible. In addition, other objects, desirable features, and characteristics will become apparent from the subsequent summary and detailed description, and the appended claims, taken in conjunction with the accompanying drawings and this background.

### SUMMARY

The object is achieved in a lighting device with a sensor device for detecting the light incident on a motor vehicle and a control device for controlling at least one lamp as a function of the detected light.

The underlying idea of the invention is here that the lamps of the driver's motor vehicle used for illuminating the environment of the vehicle are controlled in such a way as to prevent the driver from being blinded by the light from his/her own vehicle reflected off of obstacles. The key aspect here is how the driver can perceive the reflected light from his/her own vehicle, i.e., regardless of the type of illumination, for example, which can also take the form of intermittent light, the luminous intensity must be averaged in such a way as to actually be able to assess whether the human eye fact blinded. For example, this can take the form of an averaging requiring at least 5/100 of a second, one or several tenths of a second, i.e., a period over which the human eye also averages the luminous intensity during intermittent illumination.

This type of averaging is not necessary given a uniform, uninterrupted illumination.

If a specific threshold intensity of the reflected light has been exceeded, a dimmer device reduces the intensity of the light emitted by the corresponding lamp, for example a front headlamp or another headlamp, in the spatial angular region resulting in a reflection toward the driver.

The invention can be used both in the front area of the motor vehicle relative to the front headlamps, as well as in the rear area relative to the rear headlights or brake lights.

The lighting device advantageously has an analyzing device with a comparison device, which actuates the dimmer device when a specific intensity level of the reflected light of the driver's vehicle has been exceeded.

In this case, the intensity threshold can be set at the factory, but also be individually adjusted for the driver. As a result, the threshold can be tailored to the adaptability of the individual eye, for example. Since the latter changes with the age of the driver, the requirements can indeed vary depending on the driver.

The sensor device can advantageously exhibit sensor element for resolving the local intensity distribution of the detected light.

As a result, it can be determined on the one hand whether a point light source is present, so that the light might potentially not be reflected light of the driver's vehicle, but rather stem from an outside light source, and the extent to which the eye of the driver is blinded by a flat reflection, for example from an exposed wall, can be estimated on the other. The reflected light here accumulates, so that the resultant blinding differs from blinding by a point exposure.

The sensor device can also detect the surface distribution of the reflected light in terms of integration, thereby providing information about the entire reflected luminous intensity.

By contrast, it is also possible to calculate a maximum point intensity from the surface distribution of luminous intensity, so as to isolate the region of maximum brightness and use it as the basis for evaluating the reflected intensity.

In addition, the analyzing device can exhibit a device for measuring changes in the local intensity distribution of light. For example, this makes it possible to identify moving light sources, so as to separate the light stemming from outside light sources from the reflected light from the driver's motor vehicle. Since the outside light cannot be influenced by controlling the lamps of the motor vehicle, other measures must be taken to prevent the driver from being blinded.

For example, the device for measuring changes in the local intensity distribution of the light exhibits an array of light-sensitive sensors, as well as a downstream microprocessor, which analyzes the intensity distribution and registers changes at consecutive points in time.

For example, a differentiation can here also be made between horizontal movements of light sources, which typically arise in the case of oncoming vehicles, and vertical movements, e.g., which can arise as the driver's vehicle approaches an obstacle. The microprocessor in conjunction with a corresponding memory device for chronologically older data comprises a response analyzing device for analyzing the change in the detected luminous intensity over time.

To prevent misinterpretations, it is especially advantageous to connect the analyzing device with a distance measuring device.

This type of distance measuring device is present in many vehicles anyway, for example as part of a distance warning device or parking assistance device.

If the corresponding distance measuring device indicates that an obstacle is approaching, blinding by light from the driver's vehicle is probable, and the requirements placed on the detection of reflected light can be lowered, making it more probable that the analyzing device will actuate the dimming device to reduce the radiated luminous intensity. To this end, the dimming device can be isolated below a specific distance threshold, or the intensity threshold can be lowered, for example.

In addition, the analyzing device can also be connected with a speed measuring device, thereby precluding a reduction in radiated luminous intensity, for example at above a certain speed, e.g., 5 km/h. In this range, it is more probable that incident light stems from other vehicles, rather than involving reflected light from the driver's vehicle.

As a whole, the reduction in radiated light can be hinged upon a value dropping below a speed threshold, a value dropping below a specific distance threshold, and a value exceeding an intensity threshold of the detected light.

If the analyzing device relays information to the dimming device to the effect that the driver is being blinded by reflected light and appropriate measures should be taken, the electrical energy supplied to the lamp can be controlled, for example. Depending on the available electronic means, this can be done by injecting a current or voltage. Given an intermittently operating lamp, pulse-width modulation or operating frequency control is also conceivable.

The acceptance angle or alignment of a light cone of the lamp can advantageously be controlled so that the alignment is directed more toward the floor, for example, and the reflected light does not make it to the eye of the driver, or the focus can be changed in such a way that the light is radiated toward the driver more diffusely or indirectly.

The dimming device can also advantageously be switched between different lamps, for example by switching from the front headlamps to fog lamps or other headlights when approaching a wall.

In addition, it is advantageous to change the color composition of the light, or introduce an optical filter in the beam path to attenuate the light. In like manner, it is conceivable to introduce an optical mask in the optical path length.

In addition to the lighting system of a motor vehicle, the invention also relates to a method for controlling a lamp of a motor vehicle for illuminating the environment of the motor vehicle.

### BRIEF DESCRIPTION OF THE DRAWINGS

The present invention will hereinafter be described in conjunction with the following drawing figures, wherein like numerals denote like elements, and:

FIG. 1 is a diagrammatic view of a section of a motor vehicle in a side view, with a beam of light emitted by a headlamp;

FIG. 2 is a diagrammatic view of the structural design of the lighting device; and

FIG. 3 is a diagrammatic view showing how the dimming device works.

### DETAILED DESCRIPTION

The following detailed description is merely exemplary in nature and is not intended to limit application and uses. Furthermore, there is no intention to be bound by any theory presented in the preceding background or summary or the following detailed description.

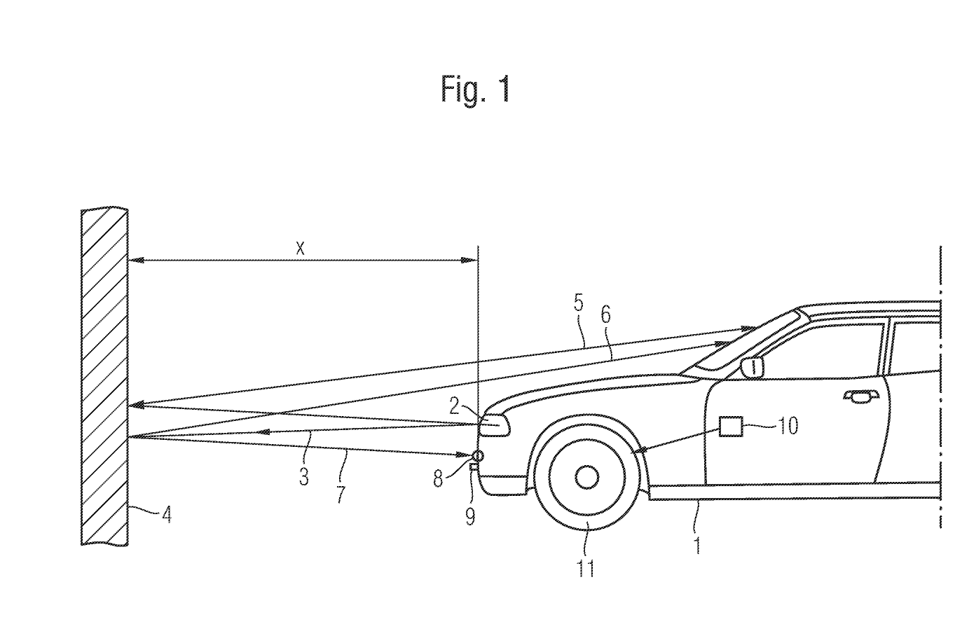

FIG. 1 presents a side view of a motor vehicle 1 with a front headlamp 2, which is normally present in vehicles in sets of two, and essentially serves to illuminate the roadway ahead of the vehicle with low beams. For example, the lamp can also be a high beam headlamp, a fog lamp or a taillight.

As denoted by the arrow 3, the light is thrown against a garage wall 4 shown in section, and from there reflected toward the vehicle. The distance between the garage wall 4 and vehicle 1 is marked X.

The garage wall 4 is also representative of other kinds of obstacles that can reflect light emitted by the lamp 2.

Examples of the reflected light are denoted by arrows 5, 6 and 7. Since the garage wall is not vapor-coated, the light is reflected diffusely, predominantly toward the vehicle 1.

The beams 5, 6 denote percentages of the reflected light from the vehicle that might hit the eye of the driver.

The driver can become blinded as a result, leading to problems recognizing the wall 4, and hence to the danger of collisions or difficulty during a parking maneuver.

The same holds true for the rear of the vehicle, where weaker lamps are most often integrated, but blinding or difficulty in recognizing the rearward environment of the vehicle can still be encountered.

7 marks the percentage of reflected light from the vehicle that is reflected to a sensor device 8, which detects the reflected light and measures its intensity.

For example, the sensor device 8 can be a single light-sensitive cell, but also an array of light-sensitive cells, or even an imaging device, for example an electronic camera. This makes it possible not just to measure the overall intensity of the reflected light, but also its local distribution.

For example, corresponding sensor device 8 could also be arranged in the area of the windshield, so that the results could be transferred even more effectively to where the eye of the driver is located.

In addition, the front area of the motor vehicle 1 can also be provided with a distance measuring device with a corresponding sensor 9 or a plurality of sensors, which measures the distance to an obstacle 4 through ultrasound or in some other conventional manner.

The vehicle can also be provided with a speed measuring device 10, for example which uses a rolling sensor on a wheel 11 to determine the rolling speed.

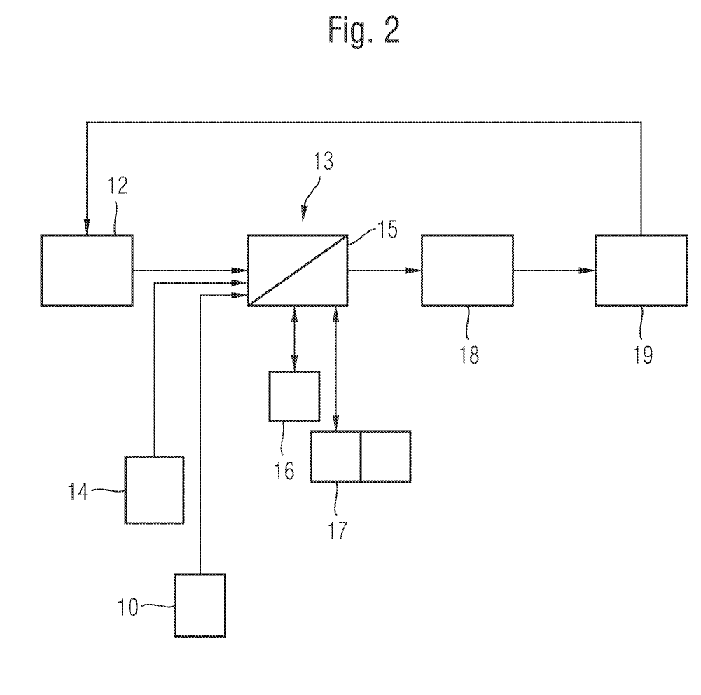

FIG. 2 is intended to diagrammatically explain the structural design of the lighting device in greater detail. The sensor device 12 is initially labeled 12. For example, the latter exhibits the individual sensors 8, and relays the corresponding intensity measuring results along with the distributions to the analyzing device 13. The latter can optionally simultaneously receive information from a speed measuring system 10 and a distance measuring system 14, so as to decide whether it makes sense to further analyze the reflected light. To his end, thresholds can be set to ensure that a further calculation only takes place, for example, if a measured distance is less than 5 m, the speed is less than 5 km, and the luminous intensity exceeds a specific, preset value. However, the mentioned limits can also be individually set in a different manner.

If the reflected light is to be analyzed, a comparison device 15 is used to compare the measured intensities with thresholds stored in a memory device 16.

At the same time or alternatively, the local distribution of reflected beams can be compared with preset and/or stored profiles from a second memory device 17, in order to distinguish between typical cases of reflection, for example between a wall and pulling into an illuminated parking garage.

At the same time, the second memory device 17 advantageously stores chronological progressions of corresponding luminous intensity or intensity distributions, with which the measuring results can be compared, so as to be able to also track the development of detected reflected luminous intensity. This makes it possible to identify moving light sources and differentiate them from reflected light from the vehicle. For example, the gradual increase in reflected luminous intensity can be registered and evaluated even while approaching an object by taking the measuring results of the distance measuring system into account.

If a critical state, i.e., the reflection of a specific minimum amount of light, lies within a specific profile, the analyzing device outputs a command to a dimming device 18, which controls or influences the lamp 19.

The corresponding change in lamp 19 can also be relayed to the sensor device 12, for example, so that the changes achieved as a result can be reproduced with the reflected light.

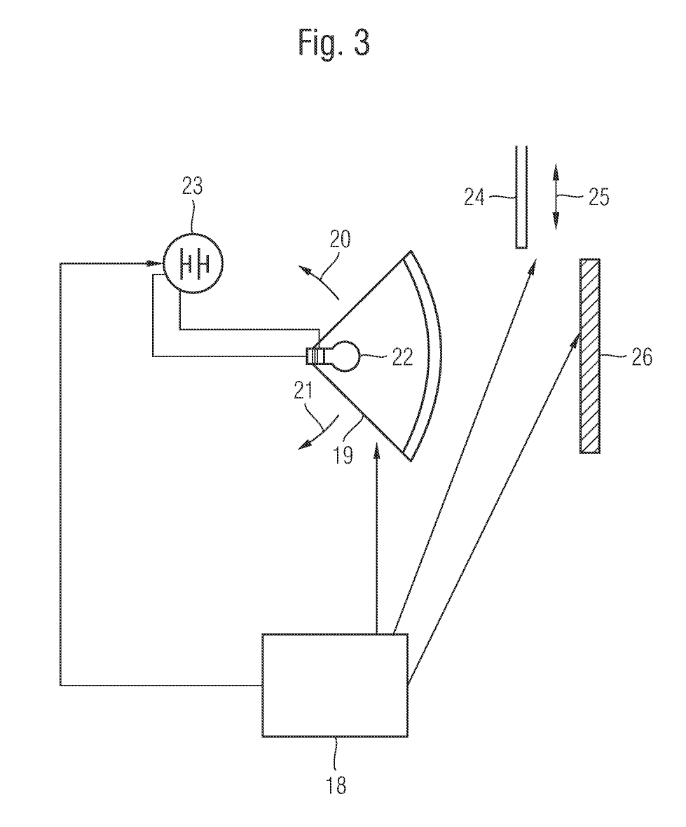

FIG. 3 is intended to show how the dimming device 18 works in greater detail. For example, the lamp 19 can be a front headlamp 2, which can be moved via pivoting in a vertical direction ad denoted by arrows 20, 21 in such a way that the driver of the vehicle 1 is no longer blinded by the reflected light. For example, the direction in which the light is radiated can also be correspondingly changed by moving the incandescent bulb 22 inside the reflector.

Another way of influencing the intensity of radiated light is to have the dimming device 18 act on the power supply 23, and reducing the current and/or voltage used to supply the lamp.

Also conceivable is to move a mask 24 denoted by a double arrow 25 in the vertical direction, and to change the transmission in an optical filter 26, for example which can be dimmed by applying an electrical voltage, as with an LCD matrix.

One or more of the mentioned measures can also be combined to prevent blinding.

Contrary to known devices, for example which are specialized to eliminate blinding by oncoming traffic, the present invention makes it possible to minimize blinding using the light from the vehicle, for example while parking.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A lighting device for a motor vehicle, comprising:
at least one lamp for illuminating an environment of the motor vehicle;
a sensor device for detecting a light reflected toward the motor vehicle;
a controlling device for controlling the at least one lamp as a function of the light reflected toward the motor vehicle;
an analyzing device for selectively measuring an intensity chronologically averaged in terms of perceptibility by a human eye of a percentage of light emitted by the at least one lamp that is reflected toward the motor vehicle; and
a dimming device for reducing an intensity of light emitted by the at least one lamp.

2. The lighting device according to claim 1, wherein the analyzing device comprises a comparison device that actuates the dimming device when exceeding a specific intensity level of a reflected percentage of radiated light.

3. The lighting device according to claim 1, wherein the sensor device comprises a sensor element for locally resolving an intensity distribution of the light.

4. The lighting device according to claim 1, wherein the sensor device detects a surface distribution of the reflected light.

5. The lighting device according to claim 1, wherein the analyzing device comprises a device for detecting changes in a local intensity distribution of the light.

6. The lighting device according to claim 1, wherein the analyzing device comprises a progression analyzing device that determines a chronological change in the light reflected toward the motor vehicle.

7. The lighting device according to claim 1, wherein the analyzing device is connected with a distance measuring device of the motor vehicle.

8. The lighting device according to claim 1, wherein the analyzing device is connected with a speed measuring device of the motor vehicle.

9. The lighting device according to claim 1, wherein the dimming device is adapted to controls an electrical energy supplied to the at least one lamp.

10. The lighting device according to claim 1, wherein the dimming device is adapted to controls an acceptance angle emitted by the at least one lamp.

11. The lighting device according to claim 1, wherein the dimming device is adapted to switch between a plurality of lamps of the motor vehicle.

12. The lighting device according to claim 1, wherein the dimming device is adapted to controls a mask arranged in a path of the light emitted by the at least one lamp.

13. The lighting device according to claim 1, wherein the dimming device is adapted to control an optical filter arranged in a path of the light emitted by the at least one lamp.

14. The lighting device according to claim 1, wherein the dimming device is adapted to control an operating frequency during an intermittent operation of the at least one lamp.

15. A method for controlling a lamp of a motor vehicle for illuminating an environment of the motor vehicle, comprising the steps of:
detecting a percentage of a light emitted by the lamp that is reflected toward the motor vehicle with a sensor device; and
analyzing the percentage of the light emitted by the lamp that is reflected toward the motor vehicle with an analyzing device; and
reducing the intensity of a reflected percentage of light with a dimming device as a function of an intensity of the reflected light.

16. The method according to claim 15, further comprising the step of wherein monitoring the reduction in the intensity of the reflected light.

17. The lighting device according to claim 1, wherein the dimming device is adapted to control an alignment of a light cone emitted by the at least one lamp.

18. The lighting device according to claim 1, wherein the dimming device is adapted to control a pulse width during an intermittent operation of the at least one lamp.

19. The method of claim 15, the intensity is an intensity distribution.
